(19) United States
(12) Patent Application Publication
(10) Pub. No.: US 2012/0307480 A1
(43) Pub. Date: Dec. 6, 2012

(54) LIGHT EMITTING DIODE MODULE AND LIGHTING APPARATUS USING THE SAME

(75) Inventor: Hyung Kun KIM, Suwon-si (KR)

(73) Assignee: SAMSUNG ELECTRONICS CO., LTD.

(21) Appl. No.: 13/484,915

(22) Filed: May 31, 2012

(30) Foreign Application Priority Data
Jun. 2, 2011 (KR) 10-2011-0053424

(51) Int. Cl. F21V 13/02; F21V 19/02; F21V 9/16

(52) U.S. Cl. 362/84

(57) ABSTRACT

A light emitting diode (LED) module and a lighting apparatus using the same are disclosed. The LED module includes a circuit board to which at least one LED emitting light of a first wavelength range is mounted, a first wavelength conversion plate to convert the light of the first wavelength range, generated from the at least one LED, to light of a second wavelength range, and a plate control module connected with the first wavelength conversion plate by a first region to selectively dispose the first wavelength conversion plate on the at least one LED by rotatably moving the first wavelength conversion plate.

### CROSS-REFERENCE TO RELATED APPLICATION

This application claims the benefit of Korean Patent Application No. 10-2011-0053424, filed on Jun. 2, 2011, in the Korean Intellectual Property Office, the disclosure of which is incorporated herein by reference.

### BACKGROUND

1. Field of the Invention

The present invention relates to a light emitting diode (LED) module and a lighting apparatus using the same, and more particularly, to an LED module having a uniform correlated color temperature (CCT) and varying a wavelength range of light, and a lighting apparatus using the same.

2. Description of the Related Art

A light emitting diode (LED) refers to a semiconductor device to convert electrical energy to optical energy, by consisting of compound semiconductor materials that generates light of a particular wavelength according to an energy band gap. Use of the LED is expanding from displays such as mobile displays and computer monitors, to backlight units (BLU) for a liquid crystal display (LCD), and even to lighting apparatuses.

An LED for a lighting apparatus needs to have high current, high luminance, and uniform luminescent characteristics, when compared to LEDs used for other fields or conventional LEDs. For example, the LED for a lighting apparatus may be formed as an LED package mounted on a package substrate and coated with transparent resin containing a wavelength conversion material to obtain white light. In this case, a quantity of the wavelength conversion material is different between an upper portion and a side portion of the LED. Accordingly, white light generated from an upper portion and a side portion of the LED package has different correlated color temperatures (CCT). That is, the white light generated from a white light generation region of the LED package is not uniform overall.

Moreover, the above-described LED package is structured by coating an LED with the transparent resin containing the wavelength conversion material. Therefore, light of a fixed wavelength range is generated through a combination of the LED and the wavelength conversion material. However, since the LED package needs to generate light having a variable wavelength range according to the application field or necessity, there is a desired for a new structure capable of varying the wavelength range of light finally emitted.

### SUMMARY

An aspect of the present invention provides a light emitting diode (LED) module having uniform correlated color temperature (CCT) and varying wavelength ranges of light, and a lighting apparatus using the same.

According to an aspect of the present invention, there is provided a light emitting diode (LED) module including a circuit board to which at least one LED emitting light of a first wavelength range is mounted, a first wavelength conversion plate to convert the light of the first wavelength range, generated from the at least one LED, to light of a second wavelength range, and a plate control module connected with the first wavelength conversion plate by a first region to selectively dispose the first wavelength conversion plate on the at least one LED by rotatably moving the first wavelength conversion plate.

The LED module may further include a second wavelength conversion plate to convert the light of the first wavelength range generated from the at least one LED to light of a third wavelength range.

The plate control module may be connected with the second wavelength conversion plate by a second region to selectively dispose the second wavelength conversion plate on the at least one LED by rotatably moving the second wavelength conversion plate.

The LED module may further include a third wavelength conversion plate to convert the light of the first wavelength range generated from the at least one LED to light of a fourth wavelength range.

The plate control module may be connected with the third wavelength conversion plate by a third region to selectively dispose the third wavelength conversion plate on the at least one LED by rotatably moving the third wavelength conversion plate.

The plate control module may include a first moving module disposed in the first region and connected with the first wavelength conversion plate, a second moving module disposed in the second region and connected with the second wavelength conversion plate, and a third moving module disposed in the third region and connected with the third wavelength conversion plate.

The first moving module to the third moving module may perform rotational movement independently from one another.

The plate control module may further include a control circuit to control rotational movements of the first moving module and the third moving module according to a control signal received from the outside.

The first wavelength conversion plate to the third wavelength conversion plate may each have a uniform thickness.

The light of the first wavelength range may be blue light and the light of the second wavelength range may be yellow light.

The light of the first wavelength range may be ultraviolet (UV) light, and the light of the second wavelength range may be any one of blue light, green light, and red light. The light of the third wavelength range may be one of two remaining lights from among the blue light, the green light, and the red light, except the light of the second wavelength range. Also, the light of the fourth wavelength range may be one of remaining lights from among the blue light, the green light, and the red light, except the lights of the second wavelength range and the third wavelength range.

The first wavelength conversion plate to the third wavelength conversion plate may be disposed close to the at least one LED in a descending order of the wavelength range of lights of the second wavelength range to the fourth wavelength range.

The first wavelength conversion plate to the third wavelength conversion plate may each include an uneven surface pattern disposed on a light extraction surface.

The LED module may further include a lens unit disposed on a light generation surface provided to the at least one LED.

Each of the at least one LED may be mounted on a package substrate that provides a mounting region for mounting the at least one LED and includes a first lead frame and a second lead frame for electrical connection with the circuit board.

The LED module may further include a support plate to support the circuit board and the plate control module.

According to another aspect of the present invention, there is provided a lighting apparatus including a housing, a circuit board mounted to the housing, at least one LED mounted on the circuit board to generate light of a first wavelength range, at least one wavelength conversion plate to convert the light of the first wavelength range to light of at least one different wavelength range, and a plate control module to rotatably move the at least one wavelength conversion plate and thereby selectively dispose the at least one wavelength conversion plate on the at least one LED.

The lighting apparatus may further include a lens cover connected to a front of the housing.

The plate control module may include a control circuit to control rotational movement of the at least one wavelength conversion plate according to a control signal received from the outside.

The housing may include a receiving space allowing rotation of the at least one wavelength conversion plate by 360°.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a perspective view illustrating a structure of a light emitting diode (LED) module according to an embodiment of the present invention;

FIG. 2 is a sectional view illustrating an LED module according to another embodiment of the present invention;

FIG. 3 is a sectional view illustrating an LED module according to still another embodiment of the present invention;

FIGS. 4 and 5 are sectional views of an LED including a lens part, according to yet another embodiment of the present invention;

FIG. 6 is a perspective view of a lighting apparatus applying the LED module of FIG. 1; and

FIG. 7 is a perspective view of a lighting apparatus according to further another embodiment of the present invention.

### DETAILED DESCRIPTION

Reference will now be made in detail to exemplary embodiments of the present invention, examples of which are illustrated in the accompanying drawings. In the description of the present invention, if detailed descriptions of related disclosed art or configuration are determined to unnecessarily make the subject matter of the present invention obscure, they will be omitted. Terms to be used below are defined based on their functions in the present invention and may vary according to users, a user's intentions, or practices. Therefore, the definitions of the terms should be determined based on the entire specification, wherein like reference numerals denote like elements throughout the drawings.

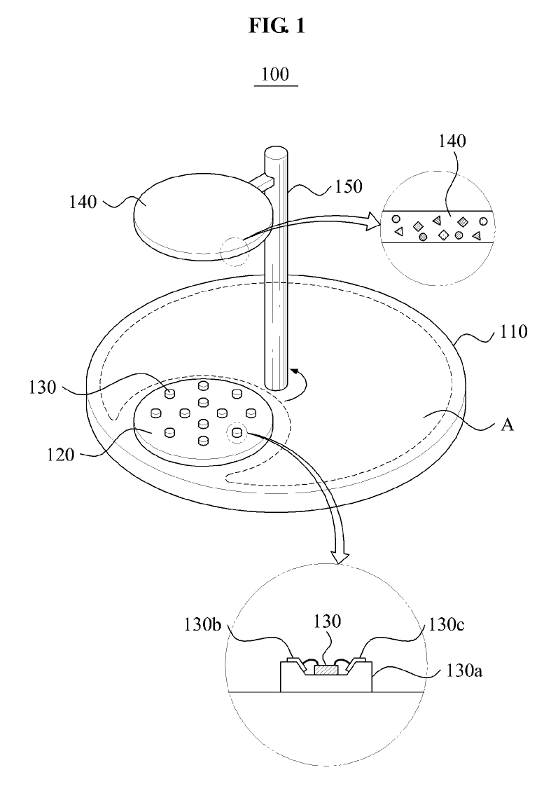

FIG. 1 is a perspective view showing a structure of a light emitting diode (LED) module 100 according to an embodiment of the present invention. Referring to FIG. 1, the LED 100 includes a support plate 110, a circuit board 120, an LED 130, a wavelength conversion plate 140, and a plate control module 150.

The supporting plate 110 supports the circuit board 120 and the plate control module 150.

The circuit board 120 is mounted to the support plate 110. A ceramic printed circuit board (PCB), an epoxy PCB, or a flame retardant (FR) 4 PCB may be used as the circuit board 120.

The LED 130 may be at least one in number and be mounted on the circuit board 120. The LED 130 may generate light of a first wavelength range. For example, the LED 130 may generate any one of blue light, green light, red light, and ultraviolet (UV) light.

The LED 130 may be a chip on board (COB) type directly mounted on the circuit board 120, or an LED package type mounted on a package substrate and then bonded to the circuit board 120.

For example, referring to an enlarged view of the LED 130 in FIG. 1, the LED 130 is in the form of an LED package mounted to a package substrate 130a. The package substrate 130a provides a mounting region for mounting the LED 130 and includes a first lead frame 130b and a second lead frame 130c for electrical connection with the circuit board 120. The LED package may be bonded onto the circuit board 120 mounted to the support plate 110.

The wavelength conversion plate 140 may convert the light of the first wavelength range, generated from the LED 130, to light of at least one different wavelength range.

More specifically, the wavelength conversion plate 140 may convert the light of the first wavelength range to light of a second wavelength range. For example, the light of the first wavelength range may be blue light while the light of the second wavelength range may be yellow light. That is, the wavelength conversion plate 140 may contain yellow phosphor particles for wavelength conversion from the blue light generated from the LED 130 to the yellow light.

Finally, the blue light passed through the wavelength conversion plate 140 and the yellow light wavelength-converted by the wavelength conversion plate 140 may be combined into white light.

The wavelength conversion plate 140 has a uniform thickness. The yellow phosphor particles may be evenly distributed on the wavelength conversion plate 140 overall. Therefore, light extracted through the wavelength conversion plate 140 may have a uniform correlated color temperature (CCT), accordingly achieving uniform white light.

Referring to a partial enlarged view of the wavelength conversion plate 140 in FIG. 1, the wavelength conversion plate 140 includes phosphor particles for converting the light of the first wavelength range.

The phosphor particles may be varied according to a number of lights to be wavelength-converted by the wavelength conversion plate 140. For example, when converting the light of the first wavelength range to the light of the second wavelength range, the wavelength conversion plate 140 may contain phosphor particles only corresponding to the light of the second wavelength. When converting the light of the first wavelength range to the light of the second wavelength range and the light of the third wavelength range, the wavelength conversion plate 140 may contain two types of phosphor particles corresponding to the light of the second wavelength range and the light of the third wavelength range.

The plate control module 150 may be mounted in a region where the circuit board 120 is not disposed. According to an exemplary embodiment, the plate control module 150 may be disposed in a center of the support plate 110, to be rotatably movable rather than being fixed.

The plate control module 150 may have a pole structure to control rotational movement of the wavelength conversion plate 140. The wavelength conversion plate 140 is connected to an upper end of the pole structure, so that the wavelength conversion plate 140 may stay at a predetermined distance from the LED 130.

The plate control module 150 may include a control circuit to control rotational movement of the plate control module 150 according to a control signal received from the outside. The control circuit may be built in the plate control module 150 having the pole structure, and connected to the plate control module 150 by being attached to a lower surface of the support plate 110.

When the plate control module 150 is rotatably moved according to the control signal, the wavelength conversion plate 140 may also perform rotational movement. Here, the control signal may be a signal that controls the wavelength conversion plate 140 to vary the wavelength range of light extracted from the LED module 100. In other words, the control signal may be a signal to move the wavelength conversion plate 140 to an LED region where the LED 130 is disposed or a non-LED region A where the LED 130 is not disposed.

For example, when the control signal for producing white light is received, the plate control module 150 may rotatably move, thereby moving the wavelength conversion plate 140 to the LED region.

Conversely, when the control signal for producing blue light is received, the plate control module 150 may rotatably move, thereby moving the wavelength conversion plate 140 to the non-LED region A. Thus, the wavelength conversion plate 140 may be rotatably moved according to the control signal, thereby selectively moving the plate control module 150.

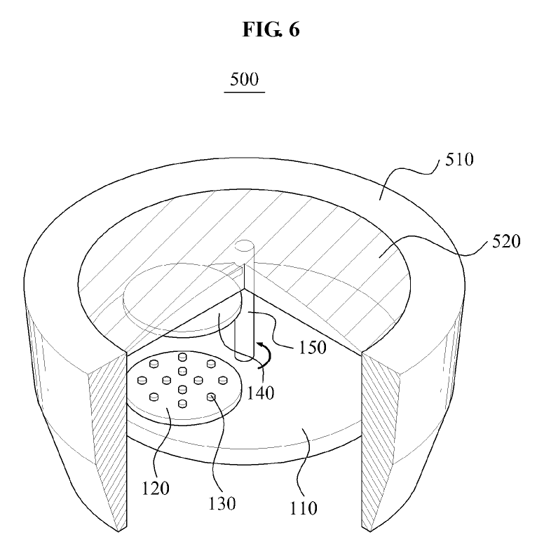

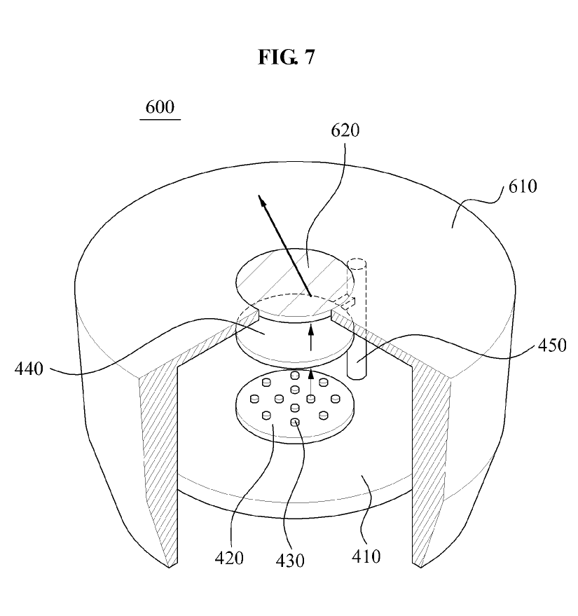

The LED module 100 shown in FIG. 1 may be mounted to a housing to be used as a lighting apparatus. The lighting apparatus may generate uniform white light, or also generate white light or blue light as necessary. The lighting apparatus will be described in further detail with reference to FIGS. 6 and 7.

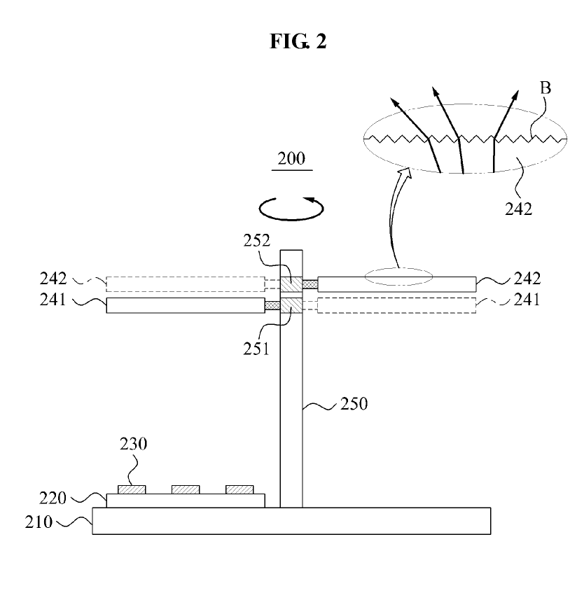

FIG. 2 is a sectional view illustrating an LED module 200 according to another embodiment of the present invention. Referring to FIG. 2, the LED module 200 includes a support plate 210, a circuit board 220, an LED 230, a first wavelength conversion plate 241, a second wavelength conversion plate 242, and a plate control module 250.

The support plate 210 may support the circuit board 220 and the plate control module 250.

The circuit board 220 is mounted to the support plate 210.

The LED 230 may be at least one in number and mounted on the circuit board 220.

The LED 230 may generate light of a first wavelength range. For example, the LED 230 may generate any one of blue light, green light, red light, and UV light.

The first wavelength conversion plate 241 converts the light of the first wavelength range, generated from the LED 230, to light of a second wavelength range.

The second wavelength conversion plate 242 converts the light of the first wavelength range to light of a third wavelength range.

The light of the first wavelength range may be red light, the light of the second wavelength range may be green light, and the light of the third wavelength range may be blue light. That is, the first wavelength conversion plate 241 may contain green phosphor particles for converting the red light generated from the LED 230 to the green light. The second wavelength conversion plate 242 may contain blue phosphor particles for converting the red light to the blue light.

Finally, the white light may be achieved by combining the red light passed through the first wavelength conversion plate 241 and the second wavelength conversion plate 242, the green light wavelength-converted by the first wavelength conversion plate 241, and the blue light wavelength-converted by the second wavelength conversion plate 242.

The first wavelength conversion plate 241 and the second wavelength conversion plate 242 each have a uniform thickness overall. The phosphor particles are uniformly distributed throughout the first wavelength conversion plate 241 and the second wavelength conversion plate 242. Accordingly, the light extracted through the first wavelength conversion plate 241 and the second wavelength conversion plate 242 has a uniform CCT, thereby achieving uniform white light.

The plate control module 250 may be disposed in a center of the support plate 210.

The plate control module 250 may have a pole structure to control rotational movement of the first wavelength conversion plate 241 and the second wavelength conversion plate 242. In addition, the plate control module 250 may include a control circuit (not shown), a first moving module 251, and a second moving module 252.

The control circuit may control operations of the first moving module 251 and the second moving module 252 according to a control signal received from the outside. The control circuit may be built in the plate control module 250.

The first moving module 251 is disposed in a first region of the plate control module 250 and connected to the first wavelength conversion plate 241. The first moving module 251 may move the first wavelength conversion plate 241 through rotational movement.

The second moving module 252 is disposed in a second region of the plate control module 250 and connected to the second wavelength conversion plate 242. The second moving module 252 may move the second wavelength conversion plate 242 through rotational movement.

The first moving module 251 and the second moving module 252 perform rotational movement independently from each other, thereby independently moving the first wavelength conversion plate 241 and the second wavelength conversion plate 242.

In FIG. 2, the light of the first wavelength range, generated from the LED 230, may be red light. The light of the second wavelength range, converted by the first wavelength conversion plate 241, may be green light. The light of the third wavelength range, converted by the second wavelength conversion plate 242, may be blue light. For example, when the control signal for producing white light is received, the plate control module 250 may rotatably move the first moving module 251 and the second moving module 252, thereby mobbing the first wavelength conversion plate 241 and the second wavelength conversion plate 242 to an LED region where the LED 230 is disposed.

When the control signal for producing red light is received, the plate control module 250 may rotatably move the first moving module 251 and the second moving module 252, thereby moving the first wavelength conversion plate 241 and the second wavelength conversion plate 242 to a non-LED region where the LED 230 is not disposed.

When the control signal for combining the red light and the green light is received, the plate control module 250 may rotatably move the first moving module 251 such that the first wavelength conversion plate 241 is disposed in the LED region, and also rotatably move the second wavelength conversion plate 252 such that the second wavelength conversion plate 242 is disposed in the non-LED region.

When the control signal for combining the red light and the blue light is received, the plate control module 250 may rotatably move the first moving module 251 such that the first wavelength conversion plate 241 is disposed in the non-LED region, and also rotatably move the second wavelength conversion plate 252 such that the second wavelength conversion plate 242 is disposed in the LED region.

Although rotational movements of the first moving module 251 and the second moving module 252 have been described thus far, when movements of the first wavelength conversion plate 241 or the second wavelength conversion plate 242 are unnecessary according to the control signal, the plate control module 250 may maintain states of the first moving module 251 and the second moving module 252.

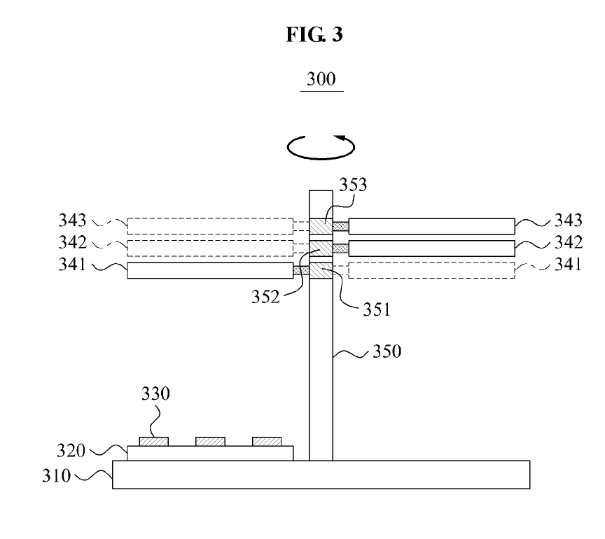

FIG. 3 is a sectional view illustrating an LED module 300 according to still another embodiment of the present invention. Referring to FIG. 3, the LED module 300 includes a support plate 310, a circuit board 320, an LED 330, a first wavelength conversion plate 341, a second wavelength conversion plate 342, a third wavelength conversion plate 343, and a plate control module 350.

The support plate 310 may support the circuit board 320 and the plate control module 350.

The circuit board 320 is mounted to the support plate 310. The LED 330 may be at least one in number and mounted on the circuit board 320. The LED 330 may generate light of a first wavelength range. For example, the LED 330 may generate any one of blue light, green light, red light, and UV light.

The first wavelength conversion plate 341 converts the light of the first wavelength range, generated from the LED 330, to light of a second wavelength range.

The second wavelength conversion plate 342 converts the light of the first wavelength range to light of a third wavelength range.

The third wavelength conversion plate 343 converts the light of the first wavelength range to light of a fourth wavelength range.

The lights of the second wavelength range to the fourth wavelength range, converted by the first wavelength conversion plate 341 to the third wavelength conversion plate 343, may be blue light, green light, and red light. More specifically, the light of the second wavelength range may be any one of the blue light, the green light, and the red light. The light of the third wavelength range may be one of two remaining lights from among the blue light, the green light, and the red light, except the light of the second wavelength range. The light of the fourth wavelength range may be a remaining one from among the blue light, the green light, and the red light, except the lights of the second wavelength range and the third wavelength range.

The first wavelength conversion plate 341 to the third wavelength conversion plate 343 may be disposed close to the LED 330 in a descending order of the wavelength range of lights of the second wavelength range to the fourth wavelength range.

The light of the first wavelength conversion plate may be the UV light, the light of the second wavelength conversion plate may be red light, the light of the third wavelength range may be green light, and the light of the fourth wavelength range may be blue light. The first wavelength conversion plate 331 that converts the UV light to the red light may be closest to the LED 330. The second wavelength conversion plate 331 that converts the UV light to the green light may be disposed on the first wavelength conversion plate 331. The third wavelength conversion plate 333 that converts the UV light to the blue light may be disposed on the second wavelength conversion plate 332, accordingly being disposed farthest from the LED 330.

The first wavelength conversion plate 341 to the third wavelength conversion plate 343 may contain phosphor particles for converting the UV light to lights of respectively corresponding wavelength ranges.

Therefore, the white light may be achieved by combining the red light wavelength-converted by the first wavelength conversion plate 341, the green wavelength-converted by the second wavelength conversion plate 342, and the blue wavelength-converted by the third wavelength conversion plate 343.

The first wavelength conversion plate 341 to the third wavelength conversion plate 343 may each have uniform thickness overall. The phosphor particles may be uniformly distributed throughout the first wavelength conversion plate 341 to the third wavelength conversion plate 343. Accordingly, the light extracted through the first wavelength conversion plate 341 to the third wavelength conversion plate 342 has a uniform CCT, thereby achieving uniform white light.

The plate control module 350 may be disposed in a center of the support plate 310.

The plate control module 350 may have a cylindrical structure to control the first wavelength conversion plate 341 to the third wavelength conversion plate 343. The plate control module 350 includes a control circuit (not shown), a first moving module 351, a second moving module 352, and a third moving module 353.

The control circuit may control operations of the first moving module 351 to the third moving module 353 according to a control signal received from the outside. The control circuit may be built in the plate control module 350.

The first moving module 351 is disposed in a first region of the plate control module 350 and connected to the first wavelength conversion plate 341. The first moving module 351 may move the first wavelength conversion plate 341 through rotational movement.

The second moving module 352 is disposed in a second region of the plate control module 350 and connected to the second wavelength conversion plate 342. The second moving module 352 may move the second wavelength conversion plate 342 through rotational movement.

The third moving module 353 is disposed in a third region of the plate control module 350 and connected to the third wavelength conversion plate 343. The third moving module 353 may move the third wavelength conversion plate 343 through rotational movement.

The first moving module 351 to the third moving module 353 perform rotational movement independently from one another, thereby independently moving the first wavelength conversion plate 341 to the third wavelength conversion plate 343, respectively.

For example, when the control signal for producing white light is received, the plate control module 350 may rotatably move the first moving module 351 to the third moving module 353, thereby moving the first wavelength conversion plate 341 to the third wavelength conversion plate 343 to an LED region where the LED 330 is disposed.

When the control signal for producing a single light such as the red light, the green light, or the blue light, the plate control module 350 may rotatably move a corresponding moving module such that, the wavelength conversion plate that converts the UV light to light of a corresponding wavelength range is disposed in the LED region.

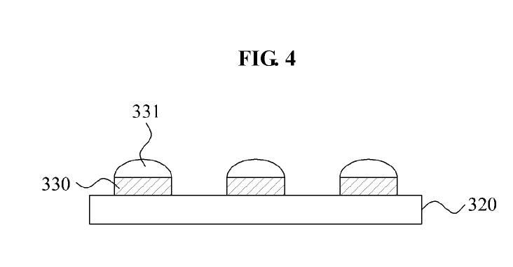

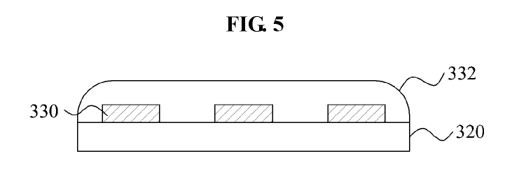

FIGS. 4 and 5 are sectional views of an LED including a lens part, according to yet another embodiment of the present invention. FIGS. 4 and 5 will be explained with reference to the circuit board 320 and the LED 330 shown in FIG. 3.

Referring to FIG. 4, a plurality of the LEDs 330 may be mounted on the circuit board 320. The plurality of LEDs 330 may each include a lens part 331 disposed on upper surfaces which are light generation surfaces. The lens part 331 may increase light extraction efficiency with respect to light of a first wavelength range, generated from upper surfaces of the plurality of LEDs 330.

Referring to FIG. 5, the plurality of LEDs 330 is mounted on the circuit board 320. A lens part 332 is formed over the whole surface of the circuit board 320 to cover an upper portion and a side portion of the plurality of LEDs 330. Accordingly, the lens part 332 may increase the light extraction efficiency with respect to the light of the first wavelength range, generated from the upper portion and the side portion of the plurality of LEDs 330.

FIG. 6 is a perspective view of a lighting apparatus 500 applying the LED module 100 of FIG. 1. The lighting apparatus 500 shown in FIG. 6 is structured in such a manner that the LED module 100 is connected to a housing 510. Referring to FIG. 6, the lighting apparatus 500 includes the housing 510, the support plate 110, the circuit board 120, the LED 130, the wavelength conversion plate 140, the plate control module 150, and a lens cover 520.

The housing 510 includes a receiving space for receiving the LED module 100. Specifically, the receiving space has a volume that enables the wavelength conversion plate 140 to rotate 360° about the LED region or the non-LED region. Therefore, the housing 510 may be designed in consideration of a surface area of the wavelength conversion plate 140 and a height of the plate control module 150.

The circuit board 120 and the plate control module 150 may be mounted to the housing 510, in a state of being mounted on the support plate 110.

The circuit board 120 and the plate control module 150 according to FIG. 6 are mounted on the support plate 110. However, the support plate 110 may be omitted and the circuit board 120 and the plate control module 150 may be directly mounted to the housing 510.

Although not shown in FIG. 6, a power supply for driving the LED module 100 and a circuit for receiving a control signal from the outside may be formed at a lower portion of the support plate 110.

The LED 130 is mounted on the circuit board 120 and generates light of a first wavelength range.

The wavelength conversion plate 140 converts the light of the first wavelength range, generated from the LED 130, to the light of the second wavelength range. The wavelength conversion plate 140 may be rotatably moved by the plate control module 150 to the LED region or the non-LED region.

The plate control module 150 rotatably moves the wavelength conversion plate 140, thereby selectively disposing the wavelength conversion plate 140 on the LED 130. Since this is described with reference to FIG. 1, a detailed description will not be repeated here.

The lens cover 520 is connected to a front of the housing 510, that is, a light extraction surface of the lighting apparatus 500. The lens cover 520 protects components received in the housing 510 from the outside. Here, the lens cover 520 has a light transmittance. Additionally, the lens cover 520 may have an upwardly convex shape to increase the light extraction efficiency. The lens cover 520 may be selectively applied according to a type of the lighting apparatus 500.

Although FIG. 6 illustrates the lighting apparatus 500 applying the LED module 100 of FIG. 1, the LED module 200 of the LED module 300 may also be mounted to the housing 510. That is, the lighting apparatus 500 may apply the LED module 200 and the LED module 300 including two or three wavelength conversion plates.

FIG. 7 is a perspective view of a lighting apparatus 600 according to further another embodiment of the present invention.

The lighting apparatus 600 shown in FIG. 7 is structured in such a manner that an LED module 400 is connected to a housing 610.

The LED module 400 has the same components as the LED module 100 shown in FIG. 1. That is, the LED module 400 includes a support plate 410, a circuit board 420, an to LED 430, a wavelength conversion plate 440, and a plate control module 450. However, the circuit board 420, the wavelength conversion plate 440, and the plate control module 450 are different from corresponding components of the LED module 100 shown in FIG. 1.

Referring to FIG. 7, the circuit board 420 on which a plurality of the LEDs 430 is mounted is disposed in a center of the support plate 410.

The plate control module 450 is disposed in a region on the support plate 410, where the plurality of LEDs 430 are not disposed. Specifically, the plate control module 450 may be disposed close to one side of the circuit board 420.

The wavelength conversion plate 440 connected with the plate control module 450 may be disposed at a predetermined interval from the circuit board 420.

When the wavelength conversion plate 440 rotatably moves under the control of the plate control module 450, the wavelength conversion plate 440 may be disposed at an upper portion of the plurality of LEDs 430 disposed in the center of the support plate 410. Therefore, the wavelength conversion plate 440 converts the light of the first wavelength range, generated from the plurality of LEDs 430, to light of at least one different wavelength ranges. The wavelength-converted light is extracted through a lens cover 620 connected to a front of the housing 610.

Different from the embodiment of FIG. 6, the lens cover 620 is disposed only in a partial region of a light extraction surface, where light is emitted from the wavelength conversion plate 440. Therefore, a region unrelated to output of light is not visually exposed.

Since the LED modules and the lighting apparatus according to the embodiments of the present invention employ the wavelength conversion plate disposed at an upper portion of the LED, uniform CCT may be achieved and the wavelength range of light may be adjusted.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A light emitting diode (LED) module comprising:
a circuit board to which at least one LED emitting light of a first wavelength range is mounted;
a first wavelength conversion plate to convert the light of the first wavelength range, generated from the at least one LED, to light of a second wavelength range; and
a plate control module connected with the first wavelength conversion plate by a first region to selectively dispose the first wavelength conversion plate on the at least one LED by rotatably moving the first wavelength conversion plate.

2. The LED module of claim 1, further comprising:
a second wavelength conversion plate to convert the light of the first wavelength range generated from the at least one LED to light of a third wavelength range.

3. The LED module of claim 2, wherein the plate control module is connected with the second wavelength conversion plate by a second region to selectively dispose the second wavelength conversion plate on the at least one LED by rotatably moving the second wavelength conversion plate.

4. The LED module of claim 3, further comprising:
a third wavelength conversion plate to convert the light of the first wavelength range generated from the at least one LED to light of a fourth wavelength range.

5. The LED module of claim 4, wherein the plate control module is connected with the third wavelength conversion plate by a third region to selectively dispose the third wavelength conversion plate on the at least one LED by rotatably moving the third wavelength conversion plate.

6. The LED module of claim 5, wherein the plate control module comprises:
a first moving module disposed in the first region and connected with the first wavelength conversion plate;
a second moving module disposed in the second region and connected with the second wavelength conversion plate; and
a third moving module disposed in the third region and connected with the third wavelength conversion plate.

7. The LED module of claim 6, wherein the first moving module to the third moving module are capable of rotational movement independent from one another.

8. The LED module of claim 6, wherein the plate control module further comprises a control circuit to control rotational movements of the first moving module and the third moving module according to a control signal received from the outside.

9. The LED module of claim 5, wherein the first wavelength conversion plate to the third wavelength conversion plate each have a uniform thickness.

10. The LED module of claim 1, wherein the light of the first wavelength range is blue light and the light of the second wavelength range is yellow light.

11. The LED module of claim 5, wherein
the light of the first wavelength range is ultraviolet (UV) light,
the light of the second wavelength range is any one of blue light, green light, and red light,
the light of the third wavelength range is one of two remaining lights from among the blue light, the green light, and the red light, except the light of the second wavelength range, and
the light of the fourth wavelength range is a remaining one from among the blue light, the green light, and the red light, except the lights of the second wavelength range and the third wavelength range.

12. The LED module of claim 5, wherein the first wavelength conversion plate to the third wavelength conversion plate are disposed close to the at least one LED in a descending order of the wavelength range of lights of the second wavelength range to the fourth wavelength range.

13. The LED module of claim 5, wherein the first wavelength conversion plate to the third wavelength conversion plate each comprise an uneven surface pattern disposed on a light extraction surface.

14. The LED module of claim 1, further comprising a lens unit disposed on a light generation surface provided to the at least one LED.

15. The LED module of claim 1, wherein each of the at least one LED is mounted on a package substrate that provides a mounting region for mounting the at least one LED and comprises a first lead frame and a second lead frame for electrical connection with the circuit board.

16. The LED module of claim 1, further comprising a support plate to support the circuit board and the plate control module.

17. A lighting apparatus comprising:
a housing;
a circuit board mounted to the housing;
at least one light emitting diode (LED) mounted on the circuit board to generate light of a first wavelength range;
at least one wavelength conversion plate to convert the light of the first wavelength range to light of at least one different wavelength range; and
a plate control module to rotatably move the at least one wavelength conversion plate and thereby selectively dispose the at least one wavelength conversion plate on the at least one LED.

18. The lighting apparatus of claim 17, further comprising a lens cover connected to a front of the housing.

19. The lighting apparatus of claim 17, wherein the plate control module comprises a control circuit to control rotational movement of the at least one wavelength conversion plate according to a control signal received from the outside.

20. The lighting apparatus of claim 17, wherein the housing comprises a receiving space allowing rotation of the at least one wavelength conversion plate by 360°.
